(19) United States
(12) Patent Application Publication
(10) Pub. No.: US 2021/0199110 A1
(43) Pub. Date: Jul. 1, 2021

(54) SYSTEMS AND METHODS FOR FLUID END EARLY FAILURE PREDICTION

(71) Applicant: U.S. Well Services, LLC, Houston, TX (US)

(72) Inventors: Arden Albert, Calgary (CA); Alexander Christinzio, Houston, TX (US)

(73) Assignee: U.S. Well Services, LLC, Houston, TX (US)

(21) Appl. No.: 17/137,570

(22) Filed: Dec. 30, 2020

Related U.S. Application Data
(60) Provisional application No. 62/955,978, filed on Dec. 31, 2019.

(51) Int. Cl. F04B 51/00; E21B 43/26; E21B 47/07; G08B 21/18

(52) U.S. Cl. CPC F04B 51/00; E21B 43/26; E21B 2200/20; G08B 21/18; E21B 47/07

(57) ABSTRACT

A method of monitoring hydraulic fracturing equipment includes training a machine learning model on training data obtained from a plurality of hydraulic fracturing operations. The training data includes a corpus of operational data associated with the hydraulic fracturing operations and corresponding health conditions associated with one or more hydraulic pump fluid ends. The method further includes receiving a set of operational data associated with an active hydraulic fracturing operation, processing the set of operational data using the trained machine learning model, and determining, based on the trained machine learning model and the input set of operational data, one or more estimated health conditions of a hydraulic pump fluid end used in the active hydraulic fracturing operation.

### CROSS-REFERENCE TO RELATED APPLICATIONS

This application claims priority to and the benefit of U.S. Provisional Application No. 62/955,978, filed Dec. 31, 2019, titled “FLUID END EARLY FAILURE PREDICTION SYSTEM AND METHOD”, the full disclosure of which is incorporated herein by reference for all purposes.

### FIELD OF INVENTION

This invention relates in general to hydraulic fracturing technology, and more particularly to early prediction of fluid end failure.

### BACKGROUND

With advancements in technology over the past few decades, the ability to reach unconventional sources of hydrocarbons has tremendously increased. Hydraulic fracturing technology has led to hydrocarbon production from previously unreachable shale formations. Hydraulic fracturing operations in oil and gas production involve the pumping of hydraulic fracturing fluids at high pressures and rates into a wellbore. The high pressure cracks the formation, allowing the fluid to enter the formation. Proppants, such as silica, are included in the fluid to wedge into the formation cracks to help maintain paths for oil and gas to escape the formation to be drawn to the surface. Hydraulic fracturing fluid can also typically contain acidic chemicals.

Due to the nature of hydraulic fracturing fluid, hydraulic fracturing pump fluid ends are subjected to harsh operating conditions. They pump abrasive slurries and acidic chemicals at high pressures and rates. Their lifespan is typically relatively short compared to other types of pumps. Maximizing fluid end lifespan is beneficial to the financial success of pressure pumping companies due at least in part to the high cost of fluid end replacement. Reducing the likelihood of fluid end failures also reduces maintenance costs and downtime.

### SUMMARY OF THE INVENTION

In accordance with one or more embodiments, a method of monitoring hydraulic fracturing equipment includes training a machine learning model on training data obtained from a plurality of hydraulic fracturing operations. The training data includes a corpus of operational data associated with the hydraulic fracturing operations and corresponding health conditions associated with one or more hydraulic pump fluid ends. The method further includes receiving a set of operational data associated with an active hydraulic fracturing operation, processing the set of operational data using the trained machine learning model, and determining, based on the trained machine learning model and the input set of operational data, one or more estimated health conditions of a hydraulic pump fluid end used in the active hydraulic fracturing operation.

In some embodiments, the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation. In some embodiments, the one or more estimated health conditions of the hydraulic pump fluid end include an estimated time to failure. In some embodiments, the one or more estimated health conditions of the hydraulic pump fluid end include indications associated with a plurality of different failure modes. In some embodiments, the method further includes determining, from the trained machine learning model, which parameters of the set of operational data are correlated with certain failure modes. In some embodiments, the method further includes receiving and processing the set of operational data through the machine learning model in real time, and generating an alert indicating a predicted failure. In some embodiments, the method further includes obtaining actual health and failure conditions of the hydraulic pump fluid end, and updating the trained machine learning model by correlating the set of operational data with the actual health and failure conditions. In accordance with another embodiment, a method of monitoring hydraulic fracturing equipment includes training a machine learning model on training data obtained from a plurality of hydraulic fracturing operations. The training data includes a corpus of operational data associated with the hydraulic fracturing operations and corresponding health conditions associated with one or more hydraulic fracturing equipment. The method further includes receiving a set of operational data associated with an active hydraulic fracturing operation, processing the set of operational data using the trained machine learning model, and determining, based on the trained machine learning model and the input set of operational data, one or more estimated health conditions of a hydraulic fracturing equipment used in the active hydraulic fracturing operation.

In some embodiments, the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation. In some embodiments, the one or more estimated health conditions of the hydraulic fracturing equipment include an estimated time to failure. In some embodiments, the one or more estimated health conditions of the hydraulic fracturing equipment include indications associated with a plurality of different failure modes. In some embodiments, the hydraulic fracturing equipment includes at least one of a hydraulic pump, a fluid end, a power end, power generation equipment, motor, pump iron, and manifold system. In some embodiments, the method further includes determining, from the trained machine learning model, which parameters of the set of operational data are correlated with certain failure modes. In some embodiments, the method further includes receiving and processing the set of operational data through the machine learning model in real time, and generating an alert indicating a predicted failure. In some embodiments, the method further includes obtaining actual health and failure conditions of the hydraulic fracturing equipment, and updating the trained machine learning model by correlating the set of operational data with the actual health and failure conditions.

In accordance with yet another embodiment, a hydraulic fracturing system includes a pump comprising a fluid end, one or more additional hydraulic fracturing equipment, a plurality of sensors configured to measure a plurality of operational parameters of the hydraulic fracturing system during an active hydraulic fracturing operation, and a control system. The control system is configured to receive a set of operational data associated with the active hydraulic fracturing operation. The set of operational data includes the plurality of operational parameters. The control system further processes the set of operational data using a trained machine learning model, and determines, based on the trained machine learning model and the set of operational data, one or more estimated health conditions of the fluid end. In some embodiments, the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation. In some embodiments, the trained machine learning model utilizes training data, the training data including a corpus of historical operational data associated with historical hydraulic fracturing operations and corresponding health conditions associated with one or more hydraulic pump fluid ends used in the historical hydraulic fracturing operations, respectively. In some embodiments, the one or more estimated health conditions of the fluid end include an estimated time to failure. In some embodiments, the one or more estimated health conditions of the hydraulic fracturing equipment include indications associated with a plurality of different failure modes, and wherein the trained machine learning model describes which parameters of the set of operational data are correlated with certain failure modes.

### BRIEF DESCRIPTION OF THE DRAWINGS

FIG. 1 is a schematic representation of an embodiment of a hydraulic fracturing system positioned at a well site.

FIG. 2 is a simplified diagrammatical representation of a hydraulic fracturing pump, in accordance with example embodiments.

FIG. 3 includes a diagram illustrating a communications network of the automated fracturing system, in accordance with various embodiments.

FIG. 4 illustrates a machine learning pipeline for carrying out the predictive abilities of the present embodiments.

FIG. 5 is a flowchart illustrating a method of hydraulic fracturing, in accordance with example embodiments.

### DETAILED DESCRIPTION OF THE INVENTION

The foregoing aspects, features, and advantages of the present disclosure will be further appreciated when considered with reference to the following description of embodiments and accompanying drawings. In describing the embodiments of the disclosure illustrated in the appended drawings, specific terminology will be used for the sake of clarity. However, the disclosure is not intended to be limited to the specific terms used, and it is to be understood that each specific term includes equivalents that operate in a similar manner to accomplish a similar purpose.

When introducing elements of various embodiments of the present disclosure, the articles “a”, “an”, “the”, and “said” are intended to mean that there are one or more of the elements. The terms “comprising”, “including”, and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment”, “an embodiment”, “certain embodiments”, or “other embodiments” of the present disclosure are not intended to be interpreted as excluding the existence of additional embodiments that also incorporate the recited features. Furthermore, reference to terms such as “above”, “below”, “upper”, “lower”, “side”, “front”, “back”, or other terms regarding orientation or direction are made with reference to the illustrated embodiments and are not intended to be limiting or exclude other orientations or directions. Additionally, recitations of steps of a method should be understood as being capable of being performed in any order unless specifically stated otherwise. Furthermore, the steps may be performed in series or in parallel unless specifically stated otherwise.

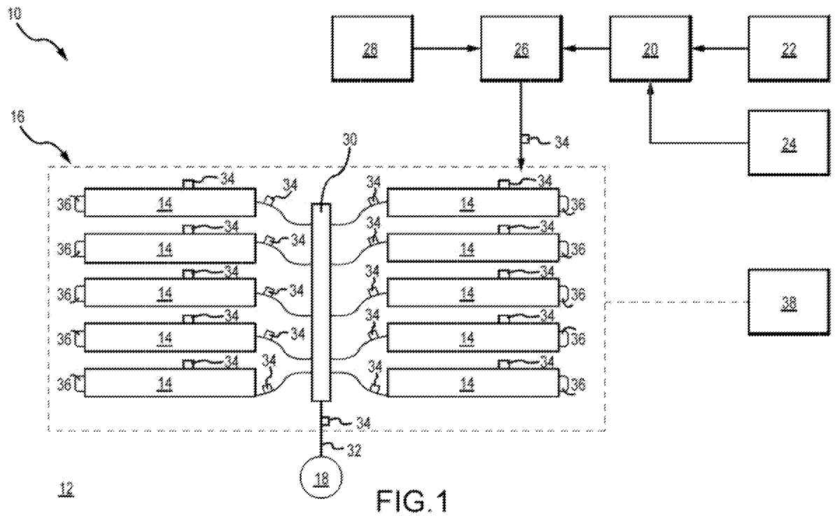

FIG. 1 is a schematic representation of an embodiment of a hydraulic fracturing system 10 positioned at a well site 12. In the illustrated embodiment, pump trucks 14, which make up a pumping system 16, are used to pressurize a fracturing fluid solution for injection into a wellhead 18. A hydration unit 20 receives fluid from a fluid source 22 via a line, such as a tubular, and also receives additives from an additive source 24. In an embodiment, the fluid is water and the additives are mixed together and transferred to a blender unit 26 where proppant from a proppant source 28 may be added to form the fracturing fluid solution (e.g., fracturing fluid) which is transferred to the pumping system 16. The pump trucks 14 may receive the fracturing fluid solution at a first pressure (e.g., 80 psi to 100 psi) and boost the pressure to around 15,000 psi for injection into the wellhead 18. In certain embodiments, the pump trucks 14 are powered by electric motors.

After being discharged from the pump system 16, a distribution system 30, such as a missile, receives the fracturing fluid solution for injection into the wellhead 18. The distribution system 30 consolidates the fracturing fluid solution from each of the pump trucks 14 (for example, via common manifold for distribution of fluid to the pumps) and includes discharge piping 32 (which may be a series of discharge lines or a single discharge line) coupled to the wellhead 18. In this manner, pressurized solution for hydraulic fracturing may be injected into the wellhead 18. In the illustrated embodiment, one or more sensors 34, 36 are arranged throughout the hydraulic fracturing system 10. In embodiments, the sensors 34 transmit flow data to a data van 38 for collection and analysis, among other things.

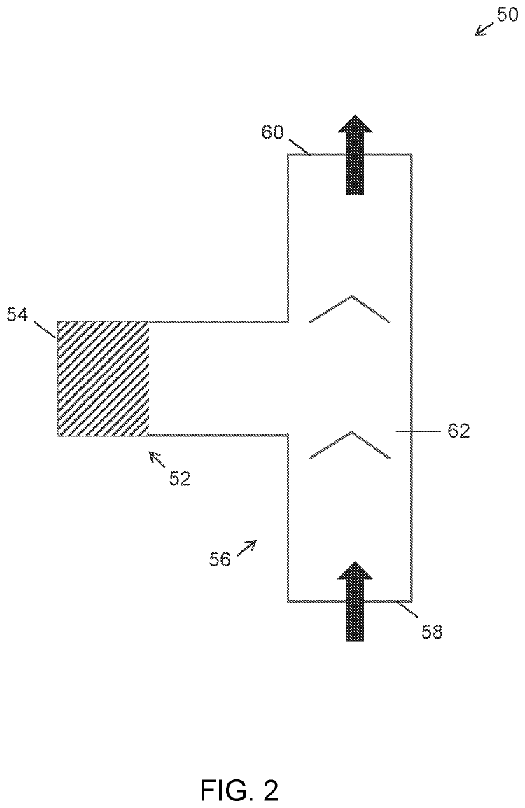

The pump trucks include hydraulic fracturing pumps that inject fracturing fluid into the wellhead. FIG. 2 is a simplified diagrammatical representation of a hydraulic fracturing pump 50, in accordance with example embodiments. The pump 50 typically includes a power end 52 which includes a displacement mechanism 54 that is moved to pump the fluid. The pump also includes a fluid end 56 through which the fluid moves. The fluid end 56 includes a suction side 58 where fluid is drawn in and a discharge side 60 where fluid is discharged from the pump 50.

Hydraulic fracturing operations in oil and gas production require the pumping of hydraulic fracturing fluids at high pressures and rates into a wellbore. The high pressure cracks the formation, allowing the fluid to enter the formation. Proppants, such as silica, are included in the fluid to wedge into the formation cracks to help maintain paths for oil and gas to escape the formation to be drawn to the surface. Hydraulic fracturing fluid can also typically contain acidic chemicals.

Due to the nature of hydraulic fracturing fluid, hydraulic fracturing pump fluid ends are subjected to harsh operating conditions. Fluid ends pump abrasive slurries and acidic chemicals at high pressures and rates. Their lifespan is typically relatively short compared to other types of pumps. Maximizing fluid end lifespan is beneficial to the financial success of pressure pumping companies due at least in part to the high cost of fluid end replacement. Reducing the likelihood of fluid end failures also reduces maintenance costs and downtime, which is important to customers.

The technology described herein utilizes machine learning to identify and quantify the factors that contribute to early fluid end failures. It monitors those factors, calculates the likelihood of each failure mode in real time using a model identified by machine learning testing, and indicates failure predictions to operators. The present technology can also collect statistics on predicted failures to help with improvements to operations and equipment specifications and designs.

Certain embodiments of the present technology are directed to hydraulic fracturing pump fluid ends, but alternate embodiments contemplate use of the technology in other applications, including pump power ends (e.g., crosshead bearings, pinion bearings, gear wear), engines and transmissions, electric motors, power generation equipment, pump iron, and high pressure manifold systems such as single bore iron runs to wellheads.

The present technology includes real-time prediction of early fluid end failure, or early failure of fluid end internal components, using data collected from multiple systems (e.g., vibration, process, environmental, maintenance, equipment make/models, power generation, customer, etc.). For the purposes of this disclosure, “real-time” includes evaluating the data as it comes in, as opposed to evaluating it after large sets of data have been acquired. Of course, there may be certain delays due to various system constraints. Fluid end failures modes or conditions may include, but are not limited to, broken stayrod, cavitation, cracked fluid end, D-ring failure, iron bracket and pump iron issues, keeper or spring failure, loose packing nut, loose pony rod clamp, missing pony rod clamp, packing drip, packing failure, packing grease issues, pony rod clamp and packing nut impacting, sanded-off suction manifold, valve or seat cut, valve and seat wear, among others.

The system can also continuously monitor its effectiveness at predicting early failures. In some embodiments, data generated in this regard can be presented in the form of a model explainability report. A process of periodically evaluating effectiveness and accuracy of the prediction algorithm(s) can help the system remains accurate as environmental conditions (e.g., weather differences in regions or seasons), job types (e.g., different customers, regions, slurry, and chemical concentrations, etc.), equipment (e.g., different makes, models, and/or configurations), or operating procedures (e.g., rates, pressures, pump usage or positioning, etc.) change over time.

The system of the present technology is also capable of determination and display of key influencers leading to specific failure modes. This information can be used at various engineering and operational levels to avoid or design out the conditions that result in early equipment failures.

Certain embodiments of the present technology analyze data from a broad range of integrated systems, all containing data regarding parameters believed to be related to early fluid failures, including, but not limited to process data from onsite equipment control systems, environmental data from onsite sensors and online weather services, maintenance information from enterprise maintenance applications, equipment make and model from enterprise maintenance applications, equipment hours from enterprise maintenance applications, vibration and damage accumulation data from third-party monitoring service, failure mode information from enterprise maintenance application or custom field applications, location and altitude data from an onsite GPS, job information from enterprise reports, power generation data from onsite turbines (if required).

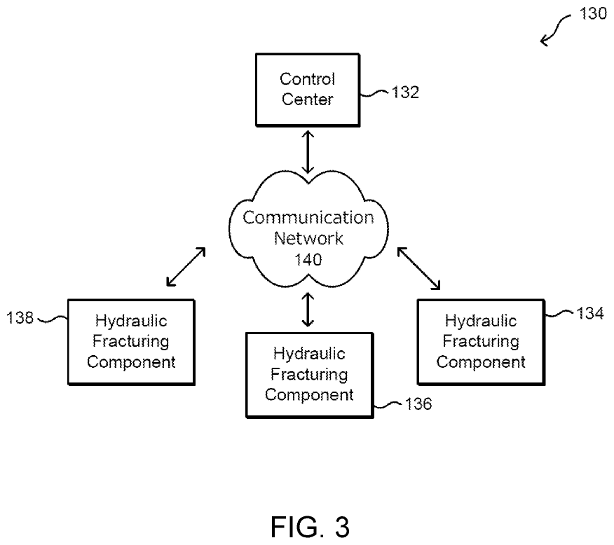

FIG. 3 includes a diagram 130 illustrating a communications network of the automated fracturing system, in accordance with various embodiments. In this example, one or more hydraulic fracturing components 138, such as, and not limited to, any of those mentioned above, may be communicative with each other via a communication network 140 such as described above with respect to FIG. 3. The components 138 may also be communicative with a control center 132 over the communication network 140. The control center 132 may be instrumented into the hydraulic fracturing system or a component. The control center 132 may be onsite, in a data van, or located remotely. The control center 132 may receive data from any of the components 138, analyze the received data, and generate control instructions for one or more of the components based at least in part on the data. In some embodiments, the control center 140 may also include a user interface, including a display for displaying data and conditions of the hydraulic fracturing system. The user interface may also enable an operator to input control instructions for the components 134. The control center 140 may also transmit data to other locations and generate alerts and notification at the control center 140 or to be received at user device remote from the control center 140.

In some embodiments, at least one of the hydraulic fracturing components 138 is a pump comprising a fluid end. The fracturing system 130 includes a plurality of sensors configured to measure a plurality of operational parameters of the hydraulic fracturing system during an active hydraulic fracturing operation. In some embodiments, the control system 132 is configured to: receive a set of operational data associated with the active hydraulic fracturing operation, the set of operational data including the plurality of operational parameters. The operational data may include one or more conditions or real time parameters of the one or more hydraulic fracturing components 134, 136, 138. The control system 130 then processes the set of operational data using a trained machine learning model and determines, based on the trained machine learning model and the set of operational data, one or more estimated health conditions of the fluid end.

In some embodiments, the set of operational data also includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation. The trained machine learning model is developed using training data, the training data including a corpus of historical operational data associated with historical hydraulic fracturing operations and corresponding health conditions associated with one or more hydraulic pump fluid ends used in the historical hydraulic fracturing operations, respectively. In some embodiments, the one or more estimated health conditions of the fluid end include an estimated time to failure. In some embodiments, the one or more estimated health conditions of the hydraulic fracturing equipment include indications associated with a plurality of different failure modes, and wherein the trained machine learning model indicates which parameters of the set of operational data are correlated with certain failure modes.

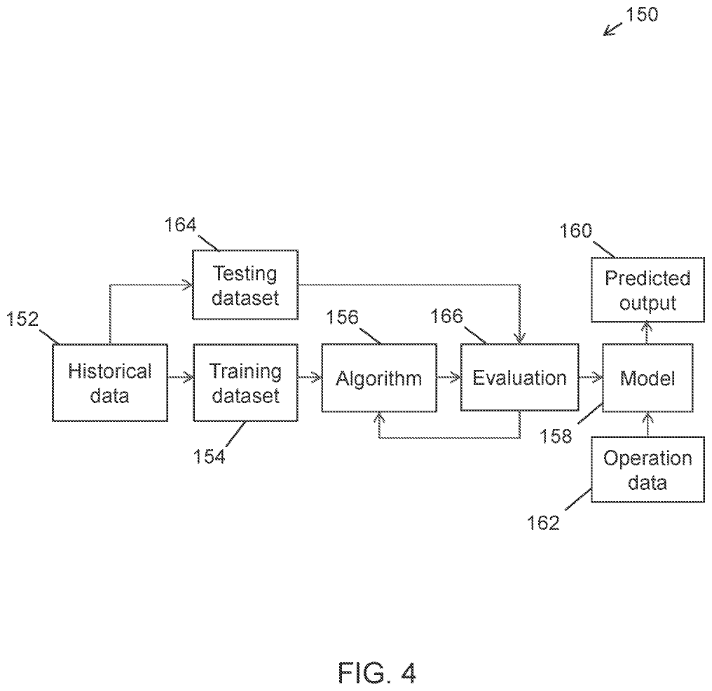

FIG. 4 illustrates a machine learning pipeline 150 for carrying out the predictive abilities of the present embodiments. In this example, training data 154 is obtained from historical data 152 and can be used in a machine learning algorithm 156 to generate one or more machine learning models 158. The historical data 152 may include any of the abovementioned parameters and the corresponding observed health condition of a fluid end. The model 158 can determine a predicted output 160 given some operation input data 162. The predicted output 160 may include various health and failure conditions of a hydraulic fracturing pump fluid end or other hydraulic fracturing equipment. The operation input data 162 may include any of the abovementioned data from a broad range of integrated systems, such, but not limited to, process data from onsite equipment control systems, environmental data from onsite sensors and online weather services, maintenance information from enterprise maintenance applications, equipment make/model from enterprise maintenance applications, equipment hours from enterprise maintenance applications, vibration and damage accumulation data from third-party monitoring service, failure mode information from enterprise maintenance application or custom field applications, location and altitude data from an onsite GPS, job information from enterprise reports, power generation data from onsite turbines.

Given a large number of such example operation data and health and failure outcomes/conditions, the machine learning model 158 can estimate or predict health and failure conditions of new operations given the operational data of the new operations. In some embodiments, the machine learning model 158 may utilize one or more neural networks or other types of models. In some embodiments, a portion of the historical data 152 can be used as a testing dataset 164. The testing dataset 164 can be used in an evaluation process 166 to test the model and refine the model 158. In some embodiments, additional training data 154 can be collected and used to update the and refine the model 158 over time.

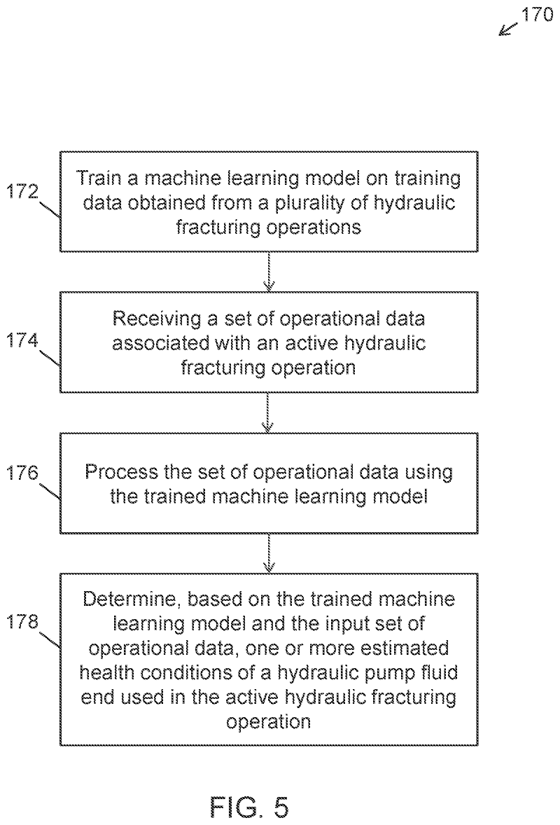

FIG. 5 is a flowchart illustrating a method 170 of hydraulic fracturing, in accordance with example embodiments. It should be noted that the method may include additional steps, fewer steps, and differently ordered steps than illustrated in this example. In this example, a machine learning model is trained (step 172) on training data obtained from a plurality of hydraulic fracturing operations. The training data includes a corpus of operational data associated with the hydraulic fracturing operations and corresponding health conditions associated with one or more hydraulic pump fluid ends. After the machine learning model is trained or otherwise obtained or accessed, a set of operational data associated with an active hydraulic fracturing operation is received (step 174) and processed (step 176) as input to the trained machine learning model.

The trained machine learning model then produces or determines (step 178), based on the input operational data, one or more estimated health conditions of a hydraulic pump fluid end used in the active hydraulic fracturing operation. In some embodiments, the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation.

In some embodiments, the one or more estimated health conditions of the hydraulic pump fluid end include an estimated time to failure. In some embodiments, the one or more estimated health conditions of the hydraulic pump fluid end include indications associated with a plurality of different failure modes. In some embodiments, the set of operational data are received and processed through the machine learning model in real time, and an alert is generated when an potential failure is predicted. In some embodiments, the trained machine learning model can also determine, based on the training data, which parameters of the set of operational data are correlated with certain failure modes. In some embodiments, the trained machine learning model can be continuously updated and improved for accuracy by obtaining actual health and failure conditions of the hydraulic pump fluid end and updating the trained machine learning model by correlating the set of operational data with the actual health and failure conditions as additional training data. The above described method is not limited to predicting fluid end failures and conditions, but rather can be applied to predicting failure and health conditions of various hydraulic fracturing equipment.

In addition, initial model training can be achieved by collecting all training and testing data into a database in the cloud. A headless Internet of Things (IoT) gateway can be onsite running custom software. This software captures data from various systems (e.g., control systems, GPS sensors, flowmeters, turbines, engines, transmissions, etc.) and forwards the data to an IoT hub in the cloud. Data about equipment lifespan, make/model, and maintenance history can be imported from an enterprise maintenance application via an application programming interface (API). Third-party data can also be imported via an API. Cloud-based machine learning services can then use a subset of that data to train and test various models to determine the correlation between the various inputs and equipment lifespan. The resulting algorithm can then be deployed in the cloud or in the field, fed the necessary parameters in real time, and the results are displayed to users and continuously updated.

The present technology presents many advantages over known systems. For example, the system is able to determine the factors contributing to early equipment failure more accurately than current methods due to more comprehensive data collection. Other systems only rely on a small subset of contributing factors. The present technology is also capable of deploying the resulting prediction algorithm onsite, and providing it all the necessary parameters in real time. The ability to understand the factors that contribute to early equipment failure will result in new operating procedures that will extend the life of the equipment.

Alternate embodiments of the present technology may incorporate the use of alternative cloud services, cloud service providers, or methods of communicating the data from the field (e.g., cellular, satellite, wireless) to accomplish the same ends discussed above. In addition, the machine learning model(s) may be embedded on equipment onsite, such as the various control systems controllers, one of the PCs, or in the IoT gateway. Furthermore, methods other than machine learning may be used to create the prediction algorithms.

The foregoing disclosure and description of the disclosed embodiments is illustrative and explanatory of the embodiments of the invention. Various changes in the details of the illustrated embodiments can be made within the scope of the appended claims without departing from the true spirit of the disclosure. The embodiments of the present disclosure should only be limited by the following claims and their legal equivalents.

1. A method of monitoring hydraulic fracturing equipment, comprising:
training a machine learning model on training data obtained from a plurality of hydraulic fracturing operations, the training data including a corpus of operational data associated with the hydraulic fracturing operations and corresponding health conditions associated with one or more hydraulic pump fluid ends;
receiving a set of operational data associated with an active hydraulic fracturing operation;
process the set of operational data using the trained machine learning model; and
determine, based on the trained machine learning model and the input set of operational data, one or more estimated health conditions of a hydraulic pump fluid end used in the active hydraulic fracturing operation.

2. The method of claim 1, wherein the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation.

3. The method of claim 1, wherein the one or more estimated health conditions of the hydraulic pump fluid end include an estimated time to failure.

4. The method of claim 1, wherein the one or more estimated health conditions of the hydraulic pump fluid end include indications associated with a plurality of different failure modes.

5. The method of claim 4, further comprising:
determining, from the trained machine learning model, which parameters of the set of operational data are correlated with certain failure modes.

6. The method of claim 1, further comprising:
receiving and processing the set of operational data through the machine learning model in real time; and
generating an alert indicating a predicted failure.

7. The method of claim 1, further comprising:
obtaining actual health and failure conditions of the hydraulic pump fluid end; and
updating the trained machine learning model by correlating the set of operational data with the actual health and failure conditions.

8. A method of monitoring hydraulic fracturing equipment, comprising:
training a machine learning model on training data obtained from a plurality of hydraulic fracturing operations, the training data including a corpus of operational data associated with the hydraulic fracturing operations and corresponding health conditions associated with one or more hydraulic fracturing equipment;
receiving a set of operational data associated with an active hydraulic fracturing operation;
processing the set of operational data using the trained machine learning model; and
determining, based on the trained machine learning model and the input set of operational data, one or more estimated health conditions of a hydraulic fracturing equipment used in the active hydraulic fracturing operation.

9. The method of claim 8, wherein the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation.

10. The method of claim 8, wherein the one or more estimated health conditions of the hydraulic fracturing equipment include an estimated time to failure.

11. The method of claim 8, wherein the one or more estimated health conditions of the hydraulic fracturing equipment include indications associated with a plurality of different failure modes.

12. The method of claim 11, further comprising:
determining, from the trained machine learning model, which parameters of the set of operational data are correlated with certain failure modes.

13. The method of claim 8, further comprising:
receiving and processing the set of operational data through the machine learning model in real time; and
generating an alert indicating a predicted failure.

14. The method of claim 8, further comprising:
obtaining actual health and failure conditions of the hydraulic fracturing equipment; and
updating the trained machine learning model by correlating the set of operational data with the actual health and failure conditions.

15. The method of claim 8, wherein the hydraulic fracturing equipment includes at least one of a hydraulic pump, a fluid end, a power end, power generation equipment, pump iron, and manifold system.

16. A hydraulic fracturing system, comprising:
a pump comprising a fluid end;
one or more additional hydraulic fracturing equipment;
a plurality of sensors configured to measure a plurality of operational parameters of the hydraulic fracturing system during an active hydraulic fracturing operation; and
a control system, the control system configured to:
receive a set of operational data associated with the active hydraulic fracturing operation, the set of operational data including the plurality of operational parameters;
process the set of operational data using a trained machine learning model; and
determine, based on the trained machine learning model and the set of operational data, one or more estimated health conditions of the fluid end.

17. The system of claim 16, wherein the set of operational data includes one or more of environmental conditions, equipment specifications, operating specifications, equipment hours, damage accumulation data, vibration parameters, temperature parameters, flow rate parameters, pressure parameters, speed, and motion counts associated with the active hydraulic fracturing operation.

18. The system of claim 16, wherein the trained machine learning model utilizes training data, the training data including a corpus of historical operational data associated with historical hydraulic fracturing operations and corresponding health conditions associated with one or more hydraulic pump fluid ends used in the historical hydraulic fracturing operations, respectively.

19. The method of claim 16, wherein the one or more estimated health conditions of the fluid end include an estimated time to failure.

20. The method of claim 16, wherein the one or more estimated health conditions of the hydraulic fracturing equipment include indications associated with a plurality of different failure modes, and wherein the trained machine learning model indicates which parameters of the set of operational data are correlated with certain failure modes.
